(19) United States
(12) Patent Application Publication
(10) Pub. No.: US 2017/0030213 A1
(43) Pub. Date: Feb. 2, 2017

(54) TURBINE SECTION WITH TIP FLOW VANES

(71) Applicant: Pratt & Whitney Canada Corp., Longueuil (CA)

(72) Inventors: Edward VLASIC, Baie-d'Urfe (CA); Raja RAMAMURTHY, Montreal (CA)

(21) Appl. No.: 14/814,927

(22) Filed: Jul. 31, 2015

(51) Int. Cl. F01D 11/08; F02C 3/073

(52) U.S. Cl. CPC F01D 11/08; F02C 3/073; F05D 2240/55

(57) ABSTRACT

A turbine section of a gas turbine engine comprises a gas path having an outer boundary wall. A circumferential array of turbine blades projects radially into the gas path. Each turbine blade extends in span from a hub to a tip and in chord from a leading edge to a trailing edge. A circumferential array of tip flow vanes extends radially inward from the outer boundary wall with a span corresponding generally to a radial depth of a tip leakage flow region of the turbine blades. The tip flow vanes are disposed downstream of the circumferential array of turbine blades adjacent to the trailing edge of the turbine blades.

### TECHNICAL FIELD

The application relates generally to gas turbine engines and, more particularly, to the turbine section of such engines.

### BACKGROUND OF THE ART

Due to tip leakage, the flow field in the tip region of turbine blades tends to differ from the mainstream flow across the blades. Therefore, flow from the tip of the turbine blades does not have the correct angle of attack at the leading edge of the downstream vanes or outlet struts. That is the flow from the tip of the blades does not attack the downstream vanes at the same angle as the mainstream flow and therefore, there are losses associated with this incidence. Also, due to the interaction of the tip flow with the mainstream flow, mixing losses may occur.

### SUMMARY

In one aspect, there is provided a turbine section of a gas turbine engine, the turbine section comprising: a gas path having an outer boundary wall, a turbine rotor having a circumferential array of turbine blades projecting radially into the gas path, each turbine blade extending in span from a hub to a tip and extending in chord from a leading edge to a trailing edge, a circumferential array of tip flow vanes extending radially inward from the outer boundary wall with a span corresponding generally to a radial depth (h) of a tip leakage flow region of the turbine blades, the tip flow vanes being disposed downstream of the circumferential array of turbine blades and at a short axial distance therefrom to catch a tip leakage flow before it starts mixing with a mainstream flow coming from the turbine blades.

In another aspect, there is provided a gas turbine engine comprising in serial flow communication a compressor for pressurizing incoming air, a combustor in which the air compressed by the compressor is mixed with fuel and ignited for generating a stream of combustion gases, and a turbine section for extracting energy from the combustion gases; the turbine section comprising a gas path having an outer boundary wall, a turbine rotor having a circumferential array of turbine blades projecting radially into the gas path, each turbine blade extending in span from a hub to a tip, the tip and the outer boundary wall defining a gap, a circumferential array of tip flow vanes extending radially inward from the outer boundary wall across the gap, the tip flow vanes being disposed downstream from the circumferential array of turbine blades and having an airfoil profile configured to redirect a tip leakage flow passing through the gap substantially in line with a mainstream flow leaving the turbine blade.

In a further aspect, there is provided a method of improving a flow in a turbine section of a gas turbine engine, the method comprising: tip leakage flow from a stage of turbine blades to be redirected in a direction which is generally in-line with a flow direction of a mainstream flow leaving the turbine blades.

### DESCRIPTION OF THE DRAWINGS

Reference is now made to the accompanying figures in which:

FIG. 1 is a schematic cross-sectional view of a turboprop gas turbine engine;

FIG. 2 is a schematic cross-sectional view of a turbine section of the engine shown in FIG. 1;

FIG. 3 is an isometric view of a portion of a turbine exhaust duct of the turbine section, the turbine exhaust duct comprising a circumferential array of tip flow vanes downstream of a last stage of turbine blade and upstream of an exhaust strut;

FIG. 4 is an enlarged front isometric view of the tip flow vanes projecting radially inward from the outer boundary wall of the turbine exhaust duct;

FIG. 5 is an enlarged isometric view of one of the tip flow vanes;

FIG. 6a is cross-sectional view illustrating the last stage of turbine blade in relation to the tip flow vanes;

FIG. 6b is an enlarged view illustrating the tip clearance region of the turbine blade shown FIG. 6a; and

FIG. 7 is an enlarged end view of the a portion of the circumferential array of tip flow vanes and illustrating the lean of the tip flow vanes.

### DETAILED DESCRIPTION

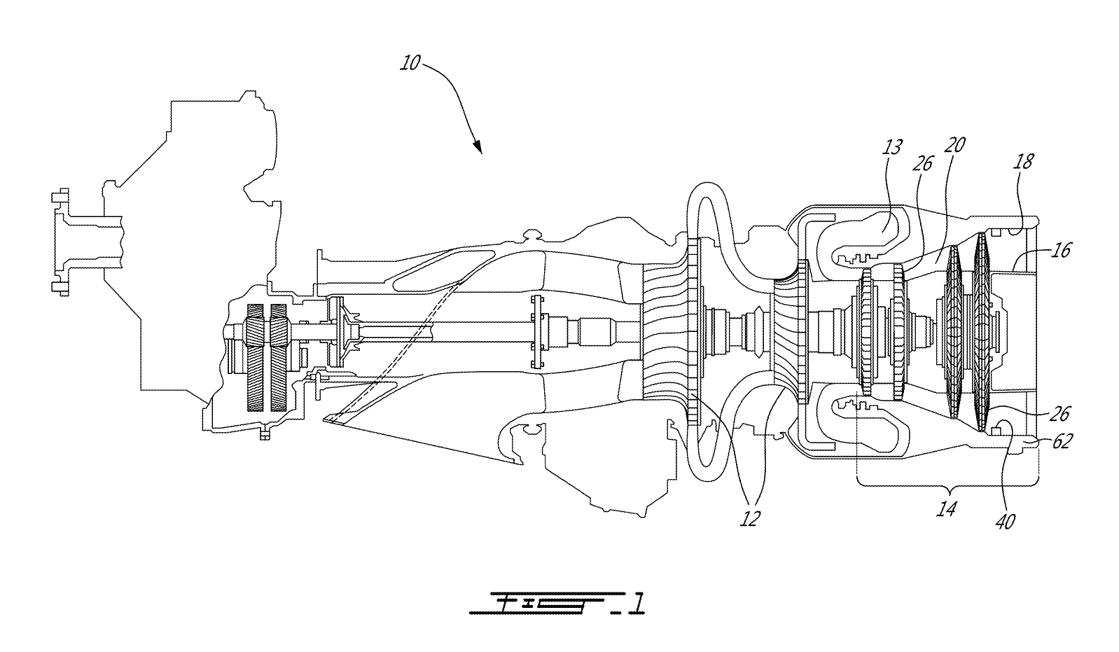

FIG. 1 illustrates a schematic of a gas turbine engine 10 of a type preferably provided for use in subsonic flight, generally comprising in serial flow communication a multistage compressor 12 for pressurizing the air, a combustor 13 in which the compressed air is mixed with fuel and ignited for generating an annular stream of hot combustion gases, and a turbine section 14 for extracting energy from the combustion gases.

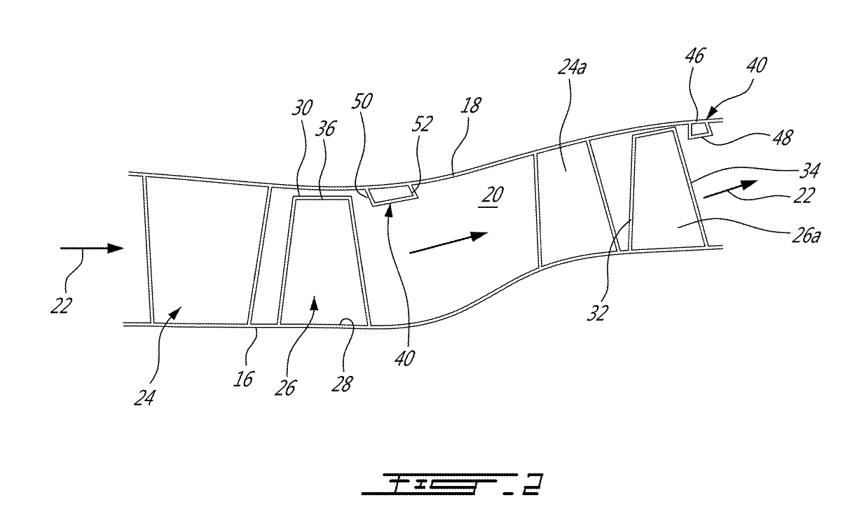

FIG. 2 illustrates a portion of the turbine section 14. The turbine section 14 has a radially inner boundary wall 16 and an outer boundary wall 18 defining therebetween a gas path 20 for channelling the combustion gases from the combustor 13, as depicted by arrows 22. As shown in FIGS. 1 and 2, the turbine section 14 may comprise more than one turbine stage, each stage comprising a stator 24 and a rotor 26 positioned downstream of the associated stator 24 with respect to a direction of the gas flow through the engine 10. Each stator 24 comprises a circumferential array of vanes extending radially across the gas path 20 for directing the incoming flow of gases at an appropriate attack angle on the downstream rotor. Each rotor 26 comprises a circumferential array of blades 26a projecting radially outward into the gas path 20. Each blade 26a extends in span from a hub 28 (0% span) to a tip 30 (100% span) and in chord from a leading edge 32 to a trailing edge 34. The tip 30 of the blades 26a is spaced from the outer boundary wall 18 by a gap 36.

Most of the flow leaving a given stage of turbine blades 26a tends to have approximately the same swirl (flow angle) from hub (0% span) to about 90-95% of the span. However, in the tip region (i.e. in the last 5 to 10% or so of the span), the flow does not have the same swirl due to tip leakage (i.e. the gas flowing over the blades 26a through the gap 36), thereby resulting in pressure losses. Also due to the interaction of the tip leakage flow (i.e. the portion of the flow which has a different swirl angle in the tip region of the blades) with the mainstream flow, there are mixing losses.

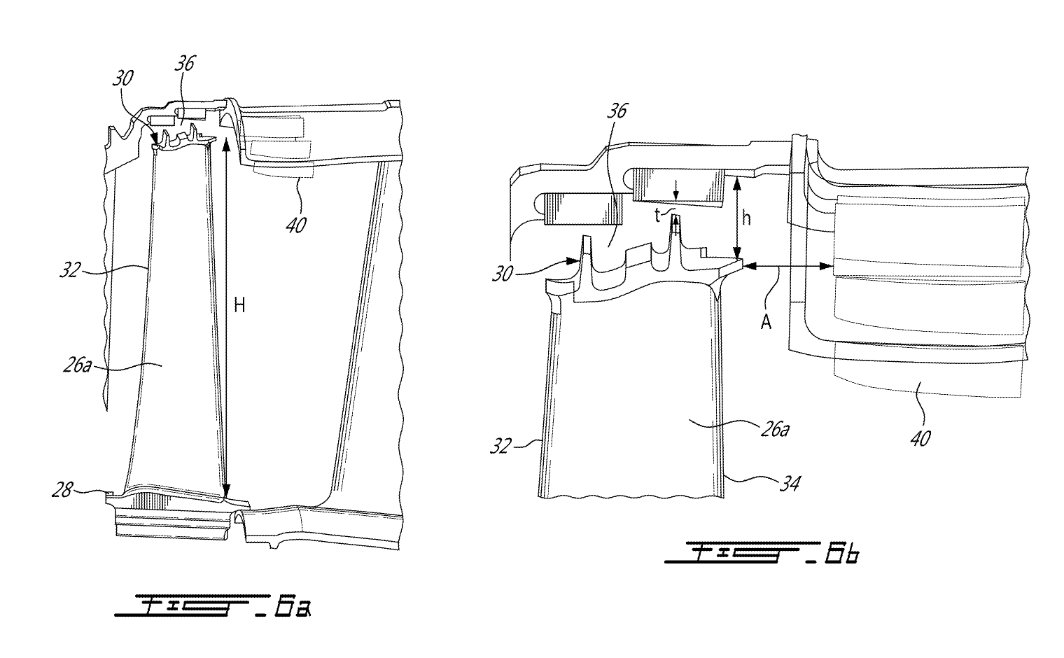

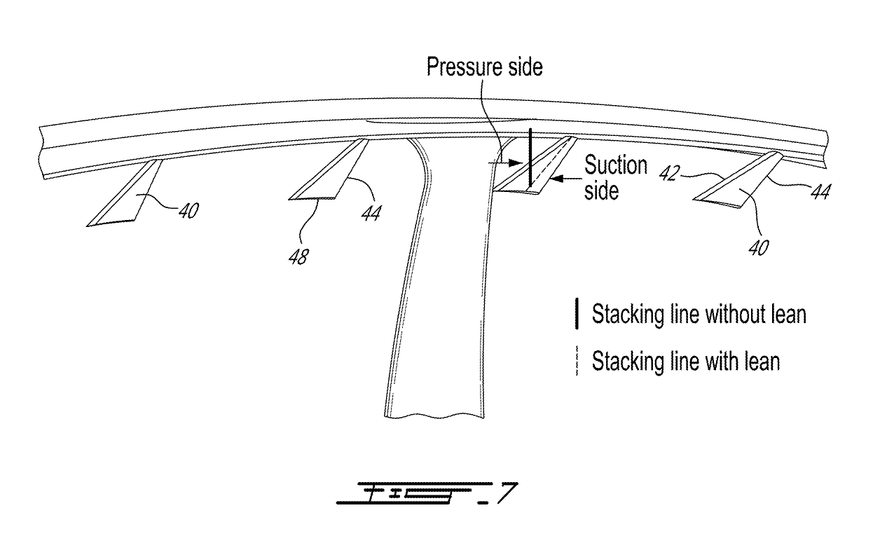

To mitigate the above mentioned losses, a circumferential array of mini-vanes or tip flow vanes 40 may be added to the outer boundary wall 18 downstream of any selected stage of turbine blades 26a. According to one embodiment, shown in FIGS. 2, 3, 6a and 6b, the tip flow vanes 40 may be disposed immediately downstream of the turbine blades 26a to catch the tip leakage flow before it starts to mix with the mainstream flow. Accordingly, the axial distance A (FIG. 6b) between the blades 26a and the mini-vanes 40 should be as small as possible, However, a minimum axial distance should be respected to account for mechanical and dynamic concerns. The minimum axial distance A must account for mechanical design constraints to make sure that there is no rubbing between the rotating blades 26a and the stationary vanes 40 and for aerodynamic considerations to ensure that the vanes do not impart a pressure wave upstream which could potentially cause dynamic excitation of the upstream blades 26a.

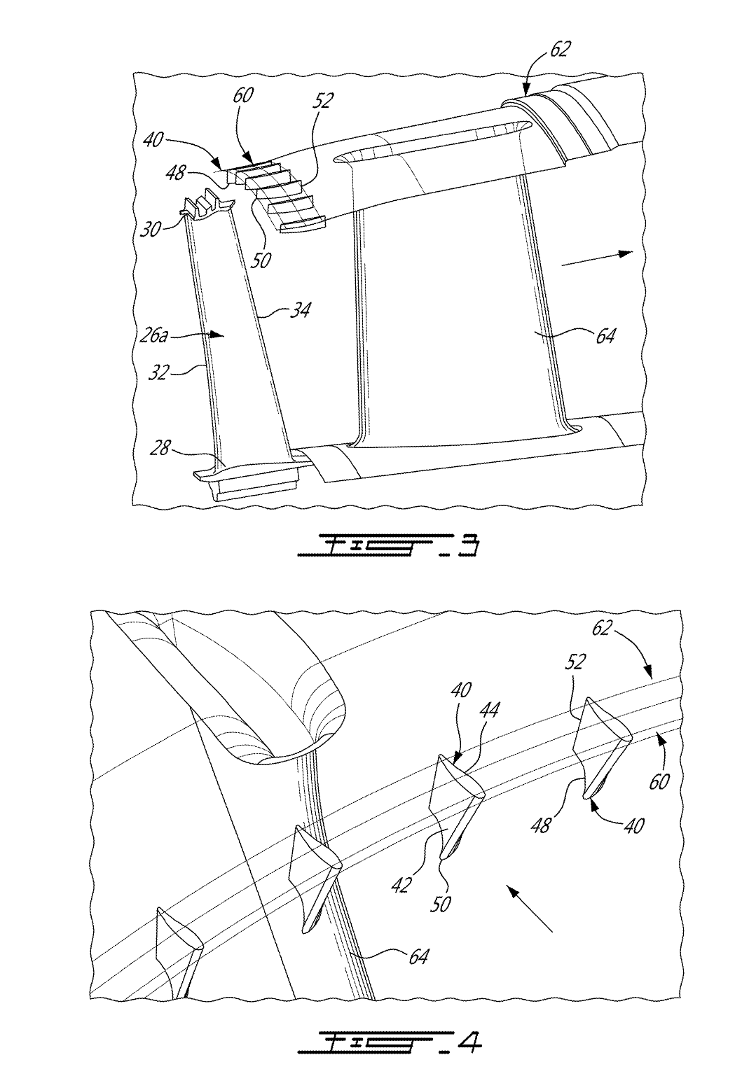

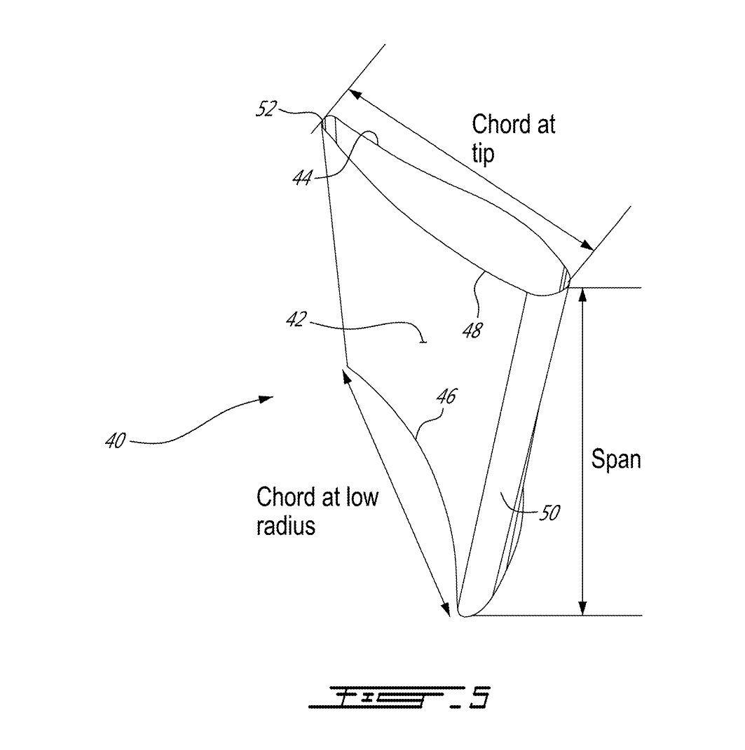

The tip flow vanes 40 are best shown in FIGS. 3 to 5. Each tip flow vane 40 is provided in the form of an airfoil having pressure and suction surfaces 42, 44 extending in span between a root 46 and a tip 48 and in chord between a leading edge 50 and a trailing edge 52.

The span of the tip flow vane 40 is function of the tip clearance (t) of the upstream turbine blade 26a, the depth (h) of tip leakage flow immediately downstream of the blade 26a and span H (FIG. 6a) of the upstream turbine blade 26a. The tip clearance (t) and the depth (h) of the tip leakage flow define a tip leakage flow region (i.e. the blade tip region in which the flow does not have the same swirl as the mainstream flow). The span of the tip flow vanes 40 is directly proportional to the tip clearance (t) (FIG. 6b) of the upstream turbine blade 26a and the radial depth of tip leakage flow region (h) (immediately downstream of tip clearance) and inversely proportional to span (H) of the upstream turbine blade 26a. (see FIG. 6a)

$$Tip flow vane span α \frac{t \sqrt{h}}{H}$$

The span of the tip flow vanes 40 may also be selected such that a portion of the vanes is exposed to a few % of the mainstream flow (i.e. the tip flow vanes may project radially inward out of the tip leakage flow region by a small percentage near the tip). According to one embodiment, aerodynamic improvements have been obtained with the tip flow vanes 40 extending from the outer boundary wall 18 by a distance up to about 10% of the span of the associated upstream turbine blades 26a. According to one embodiment, the span is equal to about 0.3 inches.

The chord of the airfoil of each tip flow vane 40 is function of the amount of flow turning/straightening the tip flow vane 40 has to perform. According to one example, the chord approximately varies from 0.76 inches at the hub or root 46 to 0.75 inches at the tip 48.

The number of tip flow vanes 40 is a function of flow turning the tip flow vanes 40 have to do. According to an embodiment, the number of tip flow vanes 40 is equal to the number of associated turbine blades 26a.

Each of the tip flow vanes 40 may also define a twist along a span thereof to provide for a different angle of attack on the tip vs the root (i.e. at low radius). The twist of the airfoil is selected to ensure proper flow incidence along all the span of the tip flow vanes 40.

The lean angle of the tip flow vanes 40 may also be selected to reduce mixing losses between the tip leakage flow and mainstream flow. For instance, the tip flow vanes 40 may lean towards the suction side of the airfoil in a circumferential direction. (see FIG. 7)

The airfoil of each tip flow vane 40 may or may not have a camber. The camber varies from hub to tip and the camber is a function of amount flow turning the tip flow vane 40 has to perform. According to one embodiment, the camber at mid-span of the tip flow vane 40 is about 20 degrees.

As shown in FIG. 2, the tip flow vanes 40 may be positioned between two stages of turbine blades 26a as for instance in an inter-turbine duct of the turbine section 14. As shown in FIGS. 3 and 4, the tip flow vanes 40 could also be added to the upstream end 60 of a turbine exhaust duct 62 immediately downstream of the last stage of turbine blades 26a. The main purpose of the turbine exhaust duct 62 is to channel the exhaust gases from the last stage of turbine blades 26a to the exit of the engine 10 with minimum losses. As best shown in FIG. 3, one or more exhaust struts 64 may be provided in the turbine exhaust duct 62 for providing a swirl which is in line with the exit gaspath of the engine. The tip flow vanes 40 change the direction flow in the tip leakage flow region so that substantially all the flow from the last stage of turbine blades 26a meets the exhaust struts 64 at the same angle, thereby minimizing pressure losses and providing for better overall aerodynamic performances. Steady state CFD analysis showed an improvement in the exhaust loss by 0.19% in terms of DP/P, where DP is the delta pressure across the turbine exhaust duct and P is the total pressure at the inlet of the turbine exhaust duct 62.

The above description is meant to be exemplary only, and one skilled in the art will recognize that changes may be made to the embodiments described without departing from the scope of the invention disclosed. For example, the tip flow vanes are not limited to turboprop applications. Indeed, the tip flow vanes could be installed in the turbine section of other types of gas turbine engines. Still other modifications which fall within the scope of the present invention will be apparent to those skilled in the art, in light of a review of this disclosure, and such modifications are intended to fall within the appended claims.

1. A turbine section of a gas turbine engine, the turbine section comprising: a gas path having an outer boundary wall, a turbine rotor having a circumferential array of turbine blades projecting radially into the gas path, each turbine blade extending in span from a hub to a tip and extending in chord from a leading edge to a trailing edge, a circumferential array of tip flow vanes extending radially inward from the outer boundary wall with a span corresponding generally to a radial depth (h) of a tip leakage flow region of the turbine blades, the tip flow vanes being disposed downstream of the circumferential array of turbine blades and at a short axial distance therefrom to catch a tip leakage flow before it starts mixing with a mainstream flow coming from the turbine blades.

2. The turbine section defined in claim 1, wherein the tip flow vanes extend from the outer boundary wall by a distance up to a value which is directly proportional to a tip clearance (t) of the turbine blades and the radial depth (h) of tip leakage flow region and inversely proportional to the span (H) of the upstream turbine blades.

3. The turbine section defined in claim 1, wherein each of the tip flow vanes defines a twist along the span thereof.

4. The turbine section defined in claim 1, wherein each of the tip flow vanes is provided in the form of an airfoil configured to redirect tip leakage flow from the tip leakage flow region of the turbine blades substantially in a same direction as a mainstream flow across the turbine blades.

5. The turbine section defined in claim 1, wherein the number of tip flow vanes is equal to the number of turbine blades.

6. The turbine section defined in claim 1, wherein the circumferential array of turbine blades is a last stage of turbine blades of the gas turbine engine, and wherein the circumferential array of tip flow vanes is positioned at an upstream end of a turbine exhaust duct.

7. The turbine section defined in claim 6, wherein the turbine exhaust duct comprises at least one strut extending through the gas path, and wherein the circumferential array of tip flow vanes are disposed upstream of the at least one strut.

8. The turbine section defined in claim 1, wherein the tip flow vanes are positioned between two turbine stages.

9. The turbine section defined in claim 1, wherein the tip flow vanes are cambered.

10. A turboprop engine comprising a turbine section as defined in claim 1.

11. The turbine section defined in claim 1, wherein the tip flow vanes extend from the outer boundary wall by a distance up to about 10% of the span of the turbine blades.

12. A gas turbine engine comprising in serial flow communication a compressor for pressurizing incoming air, a combustor in which the air compressed by the compressor is mixed with fuel and ignited for generating a stream of combustion gases, and a turbine section for extracting energy from the combustion gases; the turbine section comprising a gas path having an outer boundary wall, a turbine rotor having a circumferential array of turbine blades projecting radially into the gas path, each turbine blade extending in span from a hub to a tip, the tip and the outer boundary wall defining a gap, a circumferential array of tip flow vanes extending radially inward from the outer boundary wall across the gap, the tip flow vanes being disposed downstream from the circumferential array of turbine blades and having an airfoil profile configured to redirect a tip leakage flow passing through the gap substantially in line with a mainstream flow leaving the turbine blades.

13. The gas turbine engine defined in claim 12, wherein the tip flow vanes extend from the outer boundary wall by a distance up to about 10% of the span of the turbine blades.

14. The gas turbine engine defined in claim 11, wherein the tip flow vanes are disposed adjacent to a trailing edge of the turbine blades.

15. The gas turbine engine defined in claim 14, wherein the turbine section comprises a turbine exhaust duct, the turbine exhaust duct extending downstream from a last stage of turbine blades, and wherein the tip flow vanes are positioned at a upstream end of the turbine exhaust duct.

16. The gas turbine engine defined in claim 12 wherein the tip flow vanes are twisted and cambered.

17. A method of improving a flow in a turbine section of a gas turbine engine, the method comprising: causing a tip leakage flow from a stage of turbine blades to be redirected in a direction which is generally in-line with a flow direction of a mainstream flow leaving the turbine blades.

18. The method defined in claim 17 comprising determining a flow field in a tip leakage flow region of the turbine blades, and providing tip flow vanes on an outer boundary wall of the turbine section downstream of the turbine blades.

19. The method defined in claim 18, wherein determining a flow field in a tip leakage flow region comprises determining a depth of the tip leakage flow region, and wherein providing tip flow vanes comprises determining a span of the airfoil, the span corresponding generally to the depth of the tip leakage flow region.
